(19) United States
(12) Patent Application Publication
(10) Pub. No.: US 2008/0040360 A1
(43) Pub. Date: Feb. 14, 2008

(54) Design pattern for choice types in object oriented languages

(75) Inventors: Erik Meijer, Mercer Island, WA (US); Ralf Lammel, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/504,554

(22) Filed: Aug. 14, 2006

(51) Int. Cl. G06F 7/00

(52) U.S. Cl. 707/100

(57) ABSTRACT

A design pattern for choice types in object oriented programming languages is described herein. The design pattern enables discrimination among branch types in a type-safe and discoverable manner. Additionally, the design pattern enables object types that will eventually serve as branch types to be initially defined without placing them in a fixed class hierarchy. Hence, these object types can be initially defined without the need to anticipate that they will later be used as branch types. Furthermore, these object types can serve as branch types for multiple choice types, without the need to anticipate the names or compositions of the choice types when the branch object types are initially defined.

### BACKGROUND

In object oriented programming, it is often necessary to define a choice object type that is a sum, or co-product, of two branch object types. For example, consider the scenario in which a “customer” schema defines a structure of information corresponding to customers that are registered with a particular organization. Suppose that this organization is located in the U.S., and it has a substantial number of both domestic customers and international customers. This creates complications when designing the “customer” schema because domestic U.S. addresses include different data fields than do international addresses. For example, a U.S. address will include a two character “state” code field and a five digit “zip code” field, while an international address will include different fields of varying lengths. Additionally, an international address will include a “country” field that is unnecessary for domestic addresses. Thus, the “customer” schema may include an “address” element which is a choice of two branch elements corresponding to a domestic address and an international address. Put more simply, this means that any particular customer may have either a domestic address or an international address, but not both at any one time.

There are a number of existing techniques for defining the choice/branch relationship in object oriented programming languages. For example, in one existing technique which, inheritance is used to define the choice type as a superclass of the branch types. This approach has many limitations. For example, in this approach, the designation of a type as a branch in a choice has to be made at the time that type is designed. Also, assuming single class inheritance, each given type can only engage as branch type in one choice. Furthermore, each branch type must be a reference object type.

In another existing technique, the least-upper bound type of the branch types is selected as the type of the choice. This approach is also quite limited. For example, this approach tends to be weakly typed because the least-upper bound is often the base type object, i.e., the root of the type hierarchy. Second, the intended branch types are not easily discoverable by the programmer. In particular, the least upper bound types may be described in comments or in annotations, but the object model may not explicitly indicate the branch types of choices.

In another existing technique, the choice type is modeled as if it is a product type. Product types are easily modeled as object types, mapping the different projections of a product to different fields or properties. Once again, this approach is quite limited. For example, the application program interface on these products would be liberal, meaning that it would be easy to accidentally commit to several branches, which is not sensible for a (disjoint) choice. In fact, the mere presence of a sum, as opposed to a product, cannot be discovered by a programmer just by looking at the types in the object.

Thus, there a number of limitations of existing techniques for defining the choice/branch relationship in object oriented programming languages. The shortcomings of these techniques are not limited to those described above.

### SUMMARY

A design pattern for choice types in object oriented programming languages is described below. The design pattern enables discrimination among branch types in a type-safe and discoverable manner. Additionally, the design pattern enables object types that will eventually serve as branch types to be initially defined without placing them in a fixed class hierarchy. Hence, these object types can be initially defined without the need to anticipate that they will later be used as branch types. Furthermore, these object types can serve as branch types for multiple choice types, without the need to anticipate the names or compositions of the choice types when the branch object types are initially defined.

The design pattern may be implemented by receiving initial type inputs that define the object types which will eventually serve as branch types. These initial inputs need not designate the object types as branch types or specify any choice type with which the object types will later be associated. A choice type input may then be received that defines a choice type. The choice type input designates two or more of the previously defined object types as branch types for the choice type. Once the choice type has been defined and its branches have been designated, particular instances of the choice type may each be committed to one of the designated branch types.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The illustrative embodiments will be better understood after reading the following detailed description with reference to the appended drawings, in which:

FIG. 1 depicts an exemplary schema that includes a choice type and its corresponding branch types;

FIG. 2 is a flowchart representing an exemplary method for defining a choice type;

FIG. 3 is a flowchart representing an exemplary method for performing case discrimination on an instance of a choice type; and

FIG. 4 is a block diagram representing an exemplary computing device.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

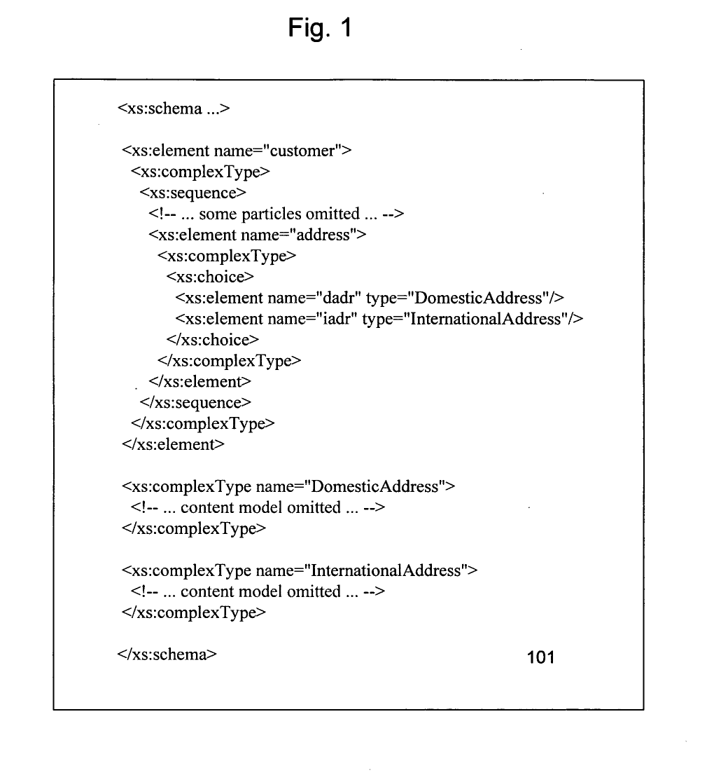

As discussed in the above “Background” section, in object oriented programming, it is often necessary to define a choice object type that is a sum of two branch object types. As an illustration of this concept, an exemplary schema that includes a choice type and its corresponding branch types is shown in FIG. 1. As shown, the extensible markup language (XML) “customer” schema of FIG. 1 includes an “address” element which is a choice of two domestic address and international address. Put more simply, this means that any particular customer may have either a domestic address or an international address, but not both at any one time. In formal notation, the “address” element is a complex element type that is a choice of two branch elements: “dadr” and “iadr”. The “dadr” element is of type “DomesticAddress.” The content model for type “DomesticAddress” is not shown in FIG. 1, but it may include elements in conformance with the data fields required for a domestic address (e.g., two character state code, five digit zip code, etc.). The “iadr” element is of type “InternationalAddress.” The content model for type “InternationalAddress” is also not shown in FIG. 1, but it may include elements in conformance with the data fields required for an international address (e.g., country code, provincial code, etc.).

When a schema such as schema 101 is bound to object types, it becomes necessary to define the object oriented choice type. As also discussed in the above “Background” section, existing techniques for defining a choice type include a number of limitations. For example, existing techniques may require an object type that serves as a branch type to be placed in a fixed class hierarchy at the time that the object type is defined. This means that, when defining such an object type, it is necessary to anticipate that the object type will eventually serve as a branch type. This also means that a particular object type can only serve as a branch type for a single corresponding choice type rather than for multiple choice types. This single corresponding choice type must also, naturally, be known at the time that the branch type is defined. Additionally, existing techniques may require that the branch types can only be reference object types and cannot be, for example, value object types. Furthermore, existing techniques may render the choice type as weakly-typed and not easily discoverable.

By contrast, the design pattern for choice types that will be described below enables discrimination among branch types in a type-safe and discoverable manner. Additionally, the design pattern enables object types that will eventually serve as branch types to be initially defined without placing them in a fixed class hierarchy. Hence, these object types can be initially defined without the need to anticipate that they will later be used as branch types. Furthermore, these object types can serve as branch types for multiple choice types, without the need to anticipate the names or compositions of the choice types when the branch object types are initially defined.

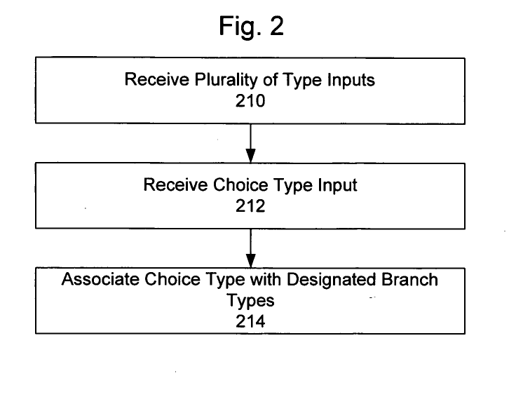

A flowchart representing an exemplary method for defining a choice type is shown in FIG. 2. At act 210, a plurality of object type inputs are received. Each of the plurality of object type inputs defines a corresponding object type. Although the object types defined by the object type inputs will eventually serve as branch types, this need not be known at the time that these object types are defined. This is in direct contrast to existing techniques in which an object type that serves as a branch type must be assigned to a choice type at the time it is defined. Exemplary type inputs for the DomesticAddress and InternationalAddress object types are shown below. As shown, each of the type inputs are defined as a class:

```
public class DomesticAddress
{
    // ... members omitted ...
}
public class InternationalAddress
{
    // ... members omitted ...
}
```

At act 212, a choice type input is received. The choice type input defines the choice type. The choice type input also designates a plurality of object types as branches of the choice type. An exemplary choice type input for the Address object type is shown below:

```
public class Address
{
private DomesticAddress dadr;
private InternationalAddress iadr;
public Address(DomesticAddress adr)
{
    if (adr == null) throw new InvalidOperationException( );
    dadr = adr;
}
public Address(InternationalAddress adr)
{
    if (adr == null) throw new InvalidOperationException( );
    iadr = adr;
}
public void As(out DomesticAddress adr)
{
    adr = dadr;
}
public void As(out InternationalAddress adr)
{
    adr = iadr;
}
}
```

The exemplary choice type input shown above is merely one possible impelementation for defining the type indexed sum relationship between the choice type and the designated branch types. Many other possible impelementations are contemplated in accordance with the design pattern described herein. As shown in the above example, the choice type is first defined as a class “Address.” The aggregation capability is then provided through private fields including “dadr” and “iadr.” The choice type input then provides two constructors for the two branch types that are implemented as “if” statements. Without loss of generality, it is assumed that non-null instances are to be passed to the constructors. In the final fragment of the choice type input, a programmatic observation of the branch is enabled that includes the method name “As” whose behavior is similar to the “as” cast operator in the C# programming language.

At act 214, the designated branch types are associated with the choice type in a type indexed sum relationship. This association enables various instances of the choice type to be committed to one of the branch types. For example, consider a first instance of “customer” schema 101 corresponding to the following data:

### Mary Rogers

### 200 Maple Ave.

### Montreal, QC H3Z2Y7

### CANADA

As shown, the first line of this example indicates that the first instance corresponds to a customer named “Mary Rogers.” The third and fourth lines of this example indicate that Mary Rogers has an international address rather than a domestic address. Accordingly, for the first instance of the “address” choice type corresponding to “Mary Rogers,” the “address” element will be committed to the “InternationalAddress” type.

As a second example, consider a second instance of “customer” schema 101 corresponding to the following data:

### Jim Smith

### 100 Main St.

### Seattle, Wash. 15501

As shown, the first line of this example indicates that the second instance corresponds to a customer named “Jim Smith.” The third line of this example indicate that Jim Smith has a domestic address rather than an international address. Accordingly, for the second instance of the “address” choice type corresponding to “Jim Smith,” the “address” element will be committed to the “DomesticAddress” type.

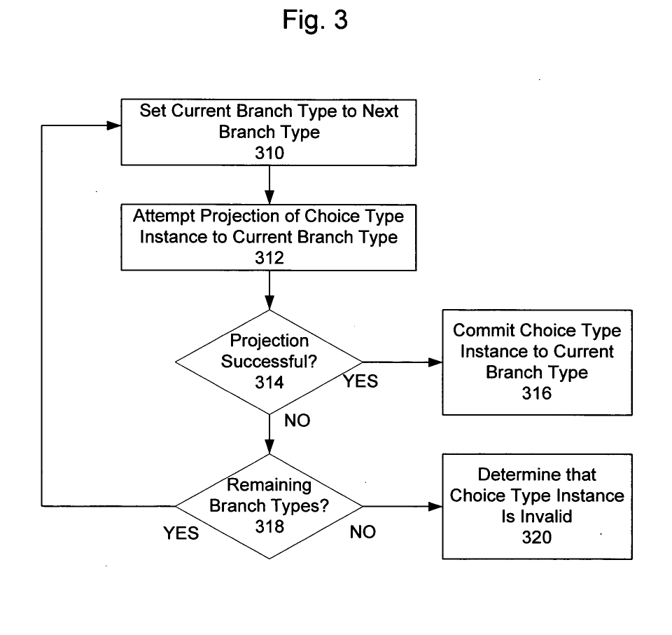

Committing an instance of the choice type to one of the corresponding branch types may be referred to as “case discrimination.” A flowchart representing an exemplary method for performing case discrimination on an instance of a choice type is shown in FIG. 3. For illustrative purposes, the method of FIG. 3 will be described below with respect to performing a case discrimination on the first instance of the “address” choice type corresponding to customer Mary Rogers. At act 310, a current branch type is set to be a next branch type. For example, at act 310, the current branch type may be set to “DomesticAddress.”

At act 312, a projection of the choice type instance to the current branch type is attempted. For example, at act 312, an attempt may be made to project Mary Rogers's address data to the “DomesticAddress” branch type. As should be appreciated, this attempt will fail for a number of reasons. In particular, while the “DomesticAddress” branch type does not include a country field, Mary Rogers's address instance includes a country field. Additionally, while the “DomesticAddress” branch type includes a five digit zip code field, Mary Rogers's address instance includes a six character postal code with both letters and numbers.

At act 314, it is determined whether the attempted projection is successful. If, as in the case of Mary Rogers and “DomesticAddress,” the attempt is not successful, then, at act 316, it is determined whether there are any remaining unexamined branch types assigned to the choice type. If there are no remaining unexamined branch types, then, at act, 320, the choice type instance is found to be invalid because it does not project to any of the designated branch types.

In the case of the “address” choice, however, there is a remaining unexamined branch type, which is the “InternationalAddress” branch type. Thus, at act 310, the current branch type is set to “InternationalAddress,” and the method is repeated. At act 312, an attempt may be made to project Mary Rogers's address data to the “InternationalAddress” branch type. As should be appreciated, this attempt will succeed. In particular, just like Mary Rogers's address, the “InternationalAddress” branch type includes a country field. Additionally, just like Mary Rogers's address, the “InternationalAddress” branch type includes a postal code field that may include both letters and numbers. Thus, at act 316, the first instance of the address type is committed to the “InternationalAddress” branch type.

Exemplary code for implementing the method of FIG. 3 will now be described. First, a new branch type object may be created and a new instance of the choice may be composed:

```
// Create an international address object
    InternationalAddress iadr = new InternationalAddress( );
    // ... synthesis of iadr object omitted
    // Compose a choice instance
    Address adr = new Address(iadr);
```

Next, a nested conditional statement that covers the branches of the choice may be constructed:

```
public void PrintAddress(Address adr)
  {
        // Temporary variables
        DomesticAddress dadr = null;
        InternationalAddress iadr = null;
        // Do a case discrimination on branch types
        if (adr.As(ref dadr))
        {
            // ... use result of cast ...
        }
        else if (adr.As(ref iadr))
        {
            // ... use result of cast ...
        }
    }
```

The exemplary use of the “As” operator that returns a Boolean (as opposed to returning void) to express the success or failure of a cast allows for a uniform treatment of value and reference types. It also allows for commitment to a branch without actually providing a non-null reference.

To reduce the complexity and time required to define a choice type, it may be advantageous to define the choice type by way of a reusable generic abstraction. Thus, the generic abstraction need only be defined a single time, while any choice type that shares the same construction as the generic abstraction can be defined by simply referring back to the generic abstraction. An exemplary reusable generic choice type abstraction of arity two is shown below:

```
public class Choice<X1, X2>
{
    private int idx;
    private X1 _x1;
    private X2 _x2;
    public Choice(X1 x1) { _x1 = x1; idx = 1; }
    public Choice(X2 x2) { _x2 = x2; idx = 2; }
    public bool As(ref X1 x1)
    {
        if (idx == 1)
        {
            x1 = _x1;
            return true;
        }
        else
            return false;
    }
    public bool As(ref X2 x2)
    {
        if (idx == 2)
        {
            x2 = _x2;
            return true;
        }
        else
            return false;
    }
}
```

The exemplary reusable generic choice type abstraction shown above enables commitment to a branch type to be stored explicitly in an integer field for the branches' index: 1 or 2. Additionally, the above example enables branch commitment to occur at constructor time, with one constructor per branch type. Furthermore, the cast method returns a Boolean to encode success (true) vs. failure (false). The branch types used in this example can be any value type or reference type.

The exemplary reusable generic choice type abstraction is easily extendable to an arity that is greater than two. Another exemplary reusable generic choice type abstraction of arity three is shown below:

```
public class Choice<X1,X2,X3>
{
    private int idx;
    private X1 _x1;
    private X2 _x2;
    private X3 _x3;
    public Choice(X1 x1) { _x1 = x1; idx = 1; }
    public Choice(X2 x2) { _x2 = x2; idx = 2; }
    public Choice(X3 x3) { _x3 = x3; idx = 3; }
    public bool As(ref X1 x1)
    {
        if (idx == 1)
        {
            x1 = _x1;
            return true;
        }
        else
            return false;
    }
    public bool As(ref X2 x2)
    {
        if (idx == 2)
        {
            x2 = _x2;
            return true;
        }
        else
            return false;
    }
    public bool As(ref X3 x3)
    {
        if (idx == 3)
        {
            x3 = _x3;
            return true;
        }
        else
            return false;
    }
}
```

Reusable generic choice type abstraction of an arity that is greater than two may also, for example, be defined as a nested choice with arities two and “n−1.” Thus, choices of an arity that is greater than two can be reduced to binary choices. An exemplary alternative implementation of a reusable generic choice type abstraction of arity 2 using a single field of type “object” is shown below:

```
public class Choice<X1, X2>
{
    private int idx;
    private object obj;
    public Choice( )
    {
    }
    public Choice(X1 x1) { obj = x1; idx = 1; }
    public Choice(X2 x2) { obj = x2; idx = 2; }
    public bool As(ref X1 x1)
    {
        if (idx == 1)
        {
            x1 = (X1)obj;
            return true;
        }
        else
            return false;
    }
    public bool As(ref X2 x2)
    {
        if (idx == 2)
        {
            x2 = (X2)obj;
            return true;
        }
        else
            return false;
    }
}
```

An instance of a choice type may only be committed to a single branch type at any one point in time. In some scenarios, a commitment to a branch type may be immutable, meaning that it is permanent and it cannot be changed. However, in other scenarios, such as, for example, programming contexts, it may be advantageous to allow for mutable commitments, meaning that an instance of the choice type can change which branch it is committed to. Mutable commitments may, for example, be enabled by adding additional code onto reusable generic choice type abstraction code such as that shown above. Exemplary mutable commitment code that may be added onto reusable generic choice type abstraction code for arity two is shown below:

```
public class Choice<X1, X2>
  {
        // ... continued from earlier ...
        public Y Accept<Y>(F<X2, Y> f2, F<X1, Y> f1)
        {
            return Accept<Y>(f1, f2);
        }
        public void Accept(S<X2> s2, S<X1> s1)
        {
            Accept(s1, s2);
        }
    }
```

### The above code includes an overloaded “Commit” method to commit or to change the commitment of an instance of the choice type.

By virtue of the generic class choice of any arity, choice types may be anonymous. This may be beneficial for certain kinds of mappings. However, it is possible to form a nominal choice type as a new class by employing inheritance whenever necessary. An example of a nominal choice type for addresses is shown below:

```
public class Address : Choice<DomesticAddress,InternationalAddress>
{
    public Address(DomesticAddress adr)
        : base(adr)
    {
    }
    public Address(InternationalAddress adr)
        : base(adr)
    {
    }
}
```

As shown above, the choice-type state and behavior such as the cast operation “As” is inherited from the choice generics. It is only necessary to rehash constructors for the new nominal type. Thus, the amount of code required to produce the nominal choice type is quite small and simple in comparison to the full choice type definition.

The cast operation of choices may enable casts to all possible branches to be systematically attempted. However, static typing may not be guarantee that all branches are covered. Thus, a completeness checking operation is provided to gurantee that all branches are covered. An exemplary completeness-checking operation will now be described. First, delegate types for the actions to be performed on the branches of a choice may be defined. The exemplary completeness checking operation honors two options. In the first option, the instance of the branch type is processed by a function that returns a value/reference of a type that is independent of the branch type. In the second option, the instance is processed instead by a void-typed function, which is therefore supposed to cause side effects. Exemplary code for these delegate types is shown below:

// Unary functions
public delegate Y F<X, Y>(X x);
// Unary statements
public delegate void S<X>(X x);

An exemplary completeness checking operation that may be extended onto choice generics of arity two is shown below:

```
public class Choice<X1, X2>
{
    public Y Accept<Y>(F<X1, Y> f1, F<X2, Y> f2)
    {
        switch (idx)
        {
            case 1: return f1(_x1);
            case 2: return f2(_x2);
            default: throw new InvalidOperationException( );
        }
    }
    public void Accept(S<X1> s1, S<X2> s2)
    {
        switch (idx)
        {
            case 1: s1(_x1); break;
            case 2: s2(_x2); break;
            default: throw new InvalidOperationException( );
        }
    }
}
```

### The code above includes an “Accept” method with type-specific “visit” operations that are provided as arguments of the Accept method.

In the “Accept” method as shown above, the enumeration of actions to be performed on the various branch types is position-oriented. The “Accept” method may also, however, be overloaded for all permutations of the branch types. Exemplary code including overloads of the “Accept” method for choice generics of arity 2 is shown below:

```
public class Choice<X1, X2>
{
    public Y Accept<Y>(F<X2, Y> f2, F<X1, Y> f1)
    {
        return Accept<Y>(f1, f2);
    }
    public void Accept(S<X2> s2, S<X1> s1)
    {
        Accept(s1, s2);
    }
}
```

### In the above code, the “Accept” method becomes position-independent and thereby fully typed-indexed.

Although the design pattern has been described above with respect to type-indexed sums/co-products, by duality the design pattern may also be applied to type-indexed products (TIP's) or tuples. TIP's are constrained such that the component types of the product must be distinct. Exemplary code for defining a TIP of arity two is shown below:

```
// Binary type-indexed products
public class TIP<X,Y> : Tuple<X,Y>
{
    public TIP(X x, Y y) : base(x, y) { }
    public void Project(out X x)
    {
        Y y;
        this.Unpack(out x, out y);
    }
    public void Project(out Y y)
    {
        X x;
        this.Unpack(out x, out y);
    }
}
```

The above code employes the concept of a Tuple <X,Y> and an overloaded “Project” method for all components types. The “Project” method attempts to unpack the tuple for each component type. The object-oriented type system takes care of the TIP property, meaning that a composition of a TIP type will be refused if the same type is listed several times as a component type.

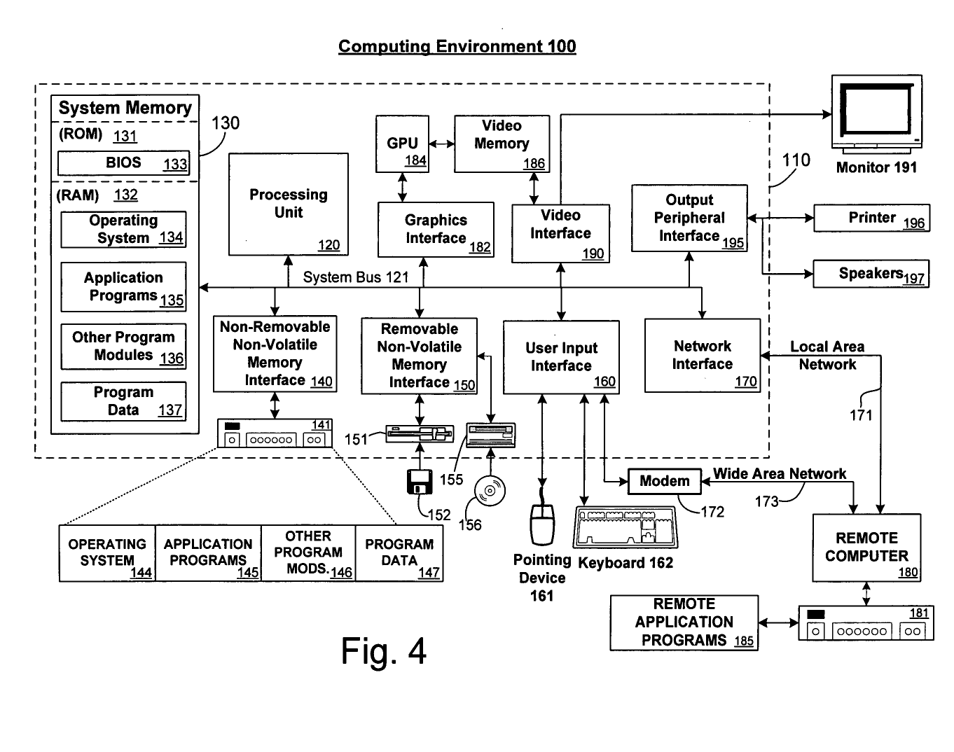

FIG. 4 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 4, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 4 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 4 provide storage of computer readable instructions, data structures, program modules and other data for the computer 110. In FIG. 4, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are exemplary and other means of establishing a communications link between the computers may be used.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A computer readable medium having computer-executable instructions for performing steps comprising:
receiving a plurality of type inputs defining a plurality of object types;
receiving a choice type input defining a choice type, the choice type input designating the plurality of object types as a plurality of branch types; and
associating the plurality of branch types with the choice type such that the choice type is a type-indexed sum of the plurality of branch types, whereby, at any particular time, any particular instance of the first choice type is defined by exactly one of the first plurality of branch types.

2. The computer readable medium of claim 1, wherein at least one of the plurality of object types is also designated as a branch type corresponding to another choice type.

3. The computer readable medium of claim 1, having further computer-executable instructions for performing the step of:
receiving a reusable generic choice definition input that defines a generic choice type that is a type-indexed sum of a plurality of generic branch types, whereby, at any particular time, any particular instance of the generic choice type is defined by exactly one the plurality of generic branch types.

4. The computer readable medium of claim 1, wherein the choice type input designates the choice type as an instance of the generic choice type, and wherein the choice type input designates the plurality of object types as a corresponding instance of the generic branch types.

5. The computer readable medium of claim 1, having further computer-executable instructions for performing the step of:
committing an instance of the choice type to a first one of the plurality branch types such that the instance of the choice type is defined by the first branch type.

6. The computer readable medium of claim 5, having further computer-executable instructions for performing the step of:
committing the instance of the choice type to a second one of the first plurality of branch types such that the instance of the choice type is defined by the second branch type.

7. The computer readable medium of claim 1, having further computer-executable instructions for performing the step of:
receiving a nominal choice type input defining a nominal choice type that inherits its state and behavior from the choice type.

8. The computer readable medium of claim 1, wherein the plurality of object types comprise reference types and value types.

9. The computer readable medium of claim 1, having further computer-executable instructions for performing the step of:
performing a completeness checking operation that guarantees attempted casts to every one of the plurality of branch types when attempting to commit an instance of the choice type to a particular branch type.

10. The computer readable medium of claim 1, having further computer-executable instructions for performing the steps of:
receiving a product type input defining a product type, the product type input designating the plurality of object types as a plurality of product branch types; and
associating the plurality of product branch types with the product type such that the product type is a type-indexed product of the plurality of product branch types, whereby any particular instance of the product type is defined by every one of the plurality of product branch types.

11. A method for performing case discrimination on an instance of a choice type, the method comprising:
(a) setting a current branch type to be a next unexamined branch type designated to the choice type;
(b) attempting to project the instance of the choice type onto the current branch type;
(c) determining whether the projection is successful;
(d) if so, then committing the instance of the choice type to the current branch type;
(e) if not, then determining whether there is a remaining unexamined branch type designated to the choice type;
(f) if so, then returning to step (a); and
(g) if not, then determining that the instance of the choice type is invalid.

12. The method of claim 11, further comprising re-committing the instance of the choice type to a different branch type at a subsequent time.

13. The method of claim 11, wherein attempting to project the instance of the choice type onto the current branch type comprises employing a Boolean expression to express success or failure of an attempted projection.

14. A method for defining a choice type, the method comprising:
receiving a plurality of type inputs defining a plurality of object types;
receiving a choice type input defining the choice type, the choice type input designating the plurality of object types as a plurality of branch types; and
associating the plurality of branch types with the choice type such that the choice type is a type-indexed sum of the plurality of branch types, whereby, at any particular time, any particular instance of the first choice type is defined by exactly one of the first plurality of branch types.

15. The method of claim 14, further comprising:
receiving a reusable generic choice definition input that defines a generic choice type that is a type-indexed sum of a plurality of generic branch types, whereby, at any particular time, any particular instance of the generic choice type is defined by exactly one the plurality of generic branch types.

16. The method of claim 14, further comprising:
committing an instance of the choice type to a first one of the plurality branch types such that the instance of the choice type is defined by the first branch type.

17. The method of claim 16, further comprising:
committing the instance of the choice type to a second one of the first plurality of branch types such that the instance of the choice type is defined by the second branch type.

18. The method of claim 14, further comprising:
receiving a nominal choice type input defining a nominal choice type that inherits its state and behavior from the choice type.

19. The method of claim 14, further comprising:
performing a completeness checking operation that guarantees attempted casts to every one of the plurality of branch types when attempting to commit an instance of the choice type to a particular branch type.

20. The method of claim 14, further comprising:
receiving a product type input defining a product type, the product type input designating the plurality of object types as a plurality of product branch types; and
associating the plurality of product branch types with the product type such that the product type is a type-indexed product of the plurality of product branch types, whereby any particular instance of the product type is defined by every one of the plurality of product branch types.
